(19) United States
(12) Patent Application Publication
(10) Pub. No.: US 2026/0078054 A1
(43) Pub. Date: Mar. 19, 2026

(54) METHOD FOR PREPARING CEMENT CLINKER UNDER OXYGEN-RICH COMBUSTION CONDITION AND CEMENT MATERIAL

(71) Applicants: CHINA BUILDING MATERIALS ACADEMY CO., LTD., Beijing (CN); CBMI CONSTRUCTION CO., LTD., Hebei (CN); CHINA NATIONAL BUILDING MATERIAL GROUP CO., LTD., Beijing (CN)

(72) Inventors: Xiao ZHI, Beijing (CN); Bin WANG, Beijing (CN); Wensheng ZHANG, Beijing (CN); Daliang CHI, Beijing (CN); Xuehong REN, Beijing (CN); Jiayuan YE, Beijing (CN); Chao ZHANG, Beijing (CN); Dong LIN, Beijing (CN); Xinyue YAO, Beijing (CN)

(73) Assignees: CHINA BUILDING MATERIALS ACADEMY CO., LTD., Beijing (CN); CBMI CONSTRUCTION CO., LTD., Hebei (CN); CHINA NATIONAL BUILDING MATERIAL GROUP CO., LTD., Beijing (CN)

(21) Appl. No.: 18/963,321

(22) Filed: Nov. 27, 2024

(30) Foreign Application Priority Data
Sep. 13, 2024 (CN) 202411288047.2

(51) Int. Cl. C04B 7/44

(52) U.S. Cl. CPC C04B 7/4476

(57) ABSTRACT

The present application belongs to the technical field of a cement material, and specifically relates to a method for preparing cement clinker and a cement material. The method for preparing cement clinker provided by the present application comprises the following steps: 1) preparing cement raw meal; 2) calcining the cement raw meal under an oxygen-rich atmosphere, the oxygen-rich atmosphere being mixed gas of oxygen and carbon dioxide in a volume ratio of (0.21-0.61):(0.39-0.79). The method for preparing the cement clinker of the present application is not easy to generate the pollutant NOₓ, the main component in the flue gas is CO₂, which is more conducive to carbon capture and sequestration, and the cement clinker obtained has a high content of C₃S, and the cement clinker has good performance (hydration effect and stability).

### FIELD OF THE INVENTION

The present application belongs to the technical field of a cement material, and specifically relates to a method for preparing cement clinker under oxygen-rich combustion condition and a cement material.

### BACKGROUND OF THE INVENTION

Cement clinker, as a semi-finished product of cement, is a key step in cement production. Cement clinker is made from limestone, clay and iron bearing raw materials as the main raw materials according to an appropriate ratio to prepare cement raw meal, which are calcined into cement clinker.

In the traditional calcination process of cement clinker, air is used as the calcining atmosphere, the temperature in the kiln is low, at the same time the decomposition rate of carbonate salts in the raw materials is low, resulting in a low rate of transformation from 2CaO·SiO₂ (C₂S) to 3CaO·SiO₂ (C₃S) during the clinker formation process, and the clinker formed has a low content of C₃S, which is not conducive to the enhancement of the quality of clinker. Moreover, the air is not conducive to complete combustion of the fuel, and N₂ and inert gases, which account for about 79% of the air, not only fail to act as combustion aids, but also lead to an increase in the generation amount of the pollutant NOₓ, while the relatively low volume fraction of CO₂ in the flue chamber leads to a high degree of difficulty in carbon capture and sequestration.

### SUMMARY OF THE INVENTION

Therefore, the present application provides a method for preparing cement clinker under oxygen-rich combustion condition, aiming at solving to a certain extent the problems of high generation amount of pollutant NOₓ, difficult carbon capture and sequestration, low C₃S content in cement clinker, and poor performance of clinker in the existing production process of cement clinker.

The present application also provides cement clinker produced using the above method and a cement material comprising it.

The present application provides a method for preparing cement clinker, comprising the following steps:
1) preparing cement raw meal; and
2) calcining the cement raw meal under an oxygen-rich atmosphere, the oxygen-rich atmosphere being mixed gas of oxygen and carbon dioxide in a volume ratio of (0.21-0.61):(0.39-0.79).

Preferably, the volume percentage of oxygen in the oxygen-rich atmosphere in step 2) is in a range from 21% to 50%.

Preferably, the volume percentage of oxygen in the oxygen-rich atmosphere in step 2) is 31% or 41%.

Preferably, the calcining in step 2) is performed at a temperature ranging from 1,430° C. to 1,470° C. for a time period ranging from 45 min to 75 min.

Preferably, the cement raw meal in step 1) comprises the following raw materials by weight: 75-85 parts of limestone, 5-15 parts of coal-fired slag, 1-5 parts of iron tailings and 5-10 parts of gas ash.

Preferably, the composition of the raw materials of the cement raw meal in step 1) further comprises fly ash; and
the fly ash is added in an amount of 0.8% to 4% of the total mass of the raw materials of the cement raw meal.

Optionally, the fly ash of the present application is obtained by combusting pulverized coal to 815° C.

Optionally, the powder of the cement raw materials for preparing the cement raw meal in step 1) has a particle size that there is 4%-6% of 80 μm sieve residue.

The present application provides cement clinker prepared by the above-described method for preparing cement clinker.

Preferably, the cement clinker comprises the following mineral phases by mass percentage: 58% to 70% of C₃S, 10% to 17% of C₂S, 2.0% to 2.7% of C₃A, 17% to 23% of C₄AF, and miscellaneous mineral phases as a balance.

Preferably, the cement clinker comprises the following mineral phases by mass percentage: 69.1% of C₃S, 11.4% of C₂S, 2.0% of C₃A, 17.4% of C₄AF, and miscellaneous mineral phases as a balance; or,
the cement clinker comprises the following mineral phases by mass percentage: 63.3% of C₃S, 14.2% of C₂S, 2.0% of C₃A, 20.4% of C₄AF and miscellaneous mineral phases as a balance.

The present application also provides a cement material comprising the cement clinker described above.

The technical solution of the present application has the following advantages.
1. The present application provides a method for preparing cement clinker, comprising the steps of 1) preparing cement raw meal; and 2) calcining the cement raw meal under an oxygen-rich atmosphere, the oxygen-rich atmosphere being mixed gas of oxygen and carbon dioxide in the volume ratio of (0.21-0.61):(0.39-0.79). The method of the present application changes the equilibrium partial pressure of CO₂ in the system and the fuel combustion mechanism by calcining under an oxygen-rich atmosphere with a specific ratio of oxygen and carbon dioxide without changing the composition and ratio of cement raw meal. With the addition of CO₂, the activation energy and the pre-exponential factor of combustion reaction of the fuel are both lowered, and the reaction rate constant is lowered, so as to increase the time of combustion peak span, effectively reduce the coal consumption in clinker calcination, increase the output of cement clinker, while increase the decomposition rate of carbonate salts in raw materials, and promote the transformation of C₂S to C₃S, which is conducive to the generation of more C₃S in the cement clinker, and the clinker prepared has a better submicroscopic morphology, in which the crystal size of Alite (its main ingredient is C₃S) becomes larger, the boundaries are clearer, the crystal morphology is excellent, and more C—S—H gel and needle crystals appear on the surface of the hydrated product. Calcining under an oxygen-rich atmosphere with a specific ratio of oxygen and carbon dioxide can significantly reduce the generation of pollutants NOₓ, the main component in the flue gas after calcination is CO₂, reducing the difficulty of separation, and carbon capture and sequestration is easier. The method for preparing cement clinker of the present application is not easy to generate pollutant NOₓ, the main component in the flue gas is CO₂, which is more conducive to carbon capture and sequestration, the cement clinker prepared has a high content of C₃S, and the cement clinker has good performance (hydration effect and stability).
2. In the method for preparing cement clinker provided by the present application, preferably, the volume percentage of oxygen in the oxygen-rich atmosphere in step 2) is in a range from 21% to 50%. By controlling the volume percentage of oxygen in the oxygen-rich atmosphere to be in a range from 21% to 50%, the compressive strength of the cement clinker obtained is significantly improved. Further, preferably, the volume percentage of oxygen in the oxygen-rich atmosphere in step 2) is 31% or 41%. By selecting an oxygen-rich atmosphere with a specific ratio of oxygen and carbon dioxide for calcination, the cement clinker obtained has good properties (hydration effect and stability), while the compressive strength of the cement clinker is higher and the quality of the cement clinker is better.
3. The method for preparing cement clinker provided in the present application can reduce the clinker coefficient when the prepared cement clinker produces cement of the same strength grade, thus reducing the carbon emission in the process of cement production, which is conducive to the low-carbon transformation of the cement industry.
4. The method for preparing cement clinker provided in the present application is highly efficient, low-carbon and environmentally friendly, and the process is simple and easy to implement, which has high environmental and economic benefits.

### BRIEF DESCRIPTION OF THE DRAWINGS

In order to more clearly illustrate the technical solutions in the specific embodiments of the present application or prior art, the accompanying drawings need to be used in the description of the specific embodiments or prior art will be briefly introduced below, and it will be obvious that the accompanying drawings in the following description are some of the embodiments of the present application, and for those skilled in the art, other drawings can be obtained according to these drawings without creative labor.

FIG. 1 shows a comparison of XRD patterns of cement clinker from Examples 1-5 and Comparative Example 1 of the present application;

FIG. 2 shows a comparison of the mass contents of free calcium oxide (f-CaO) in cement clinker from Examples 1-5 and Comparative Example 1 of the present application;

FIG. 3 shows a comparison of the compressive strength at day 3 and day 28 of the cement of the present application containing the cement clinker of Examples 1-5 and Comparative Example 1;

FIG. 4 shows a comparison of cement clinker from Example 1 (A1), Example 2 (A2) and Comparative Example 1 (A0) of the present application under a polarizing microscope (where Alite means Alite crystals, and Belite means Belite crystals);

FIG. 5 shows a comparison of cement clinker from Example 3 (A3), Example 4 (A4) and Example 5 (A5) of the present application under a polarizing microscope (where Alite means Alite crystals, and Belite means Belite crystals);

FIG. 6 shows a comparison of hydrated cement clinker from Example 1 (A1), Example 2 (A2) and Comparative Example 1 (A0) of the present application under a scanning electron microscope; and

FIG. 7 shows a comparison of hydrated cement clinker from Example 3 (A3), Example 4 (A4) and Example 5 (A5) of the present application under a scanning electron microscope.

### DETAILED DESCRIPTION OF THE INVENTION

The following examples are provided for a better and further understanding of the present application, and are not limited to the best embodiments described, and do not constitute a limitation on the content and scope of protection of the present application, and any product identical or similar to the present application derived by any person under the inspiration of the present application or by combining the features of the present application with those of other prior art will fall within the scope of protection of the present application.

Where specific experimental steps or conditions are not indicated in the examples, the operations or conditions of conventional experimental steps described in the literature in the field can be performed. Where no manufacturer is indicated for the reagents or instruments used, the reagents or instruments used are conventional reagent and products that can be obtained through market purchase.

The composition of the limestone used in the examples and comparative examples of the present application includes: 48.24% of CaO, 5.76% of SiO₂, 1.46% of Al₂O₃, 0.70% of Fe₂O₃, 1.78% of MgO, 0.30% of SO₃, 0.43% of K₂O, 0.08% of Na₂O, and 41.25% of loss-on-ignition.

The composition of coal-fired slag includes: 5.17% of CaO, 62.01% of SiO₂, 21.87% of Al₂O₃, 4.13% of Fe₂O₃, 0.26% of MgO, 0.03% of SO₃, 2.56% of K₂O, 1.07% of Na₂O, and 2.90% of loss-on-ignition.

The composition of iron tailings includes: 2.02% of CaO, 79.41% of SiO₂, 3.20% of Al₂O₃, 9.77% of Fe₂O₃, 2.04% of MgO, 0.28% of SO₃, 0.59% of K₂O, 0.23% of Na₂O, and 2.46% of loss-on-ignition; and its source comes from Anshan Jinhe Mining Co., Ltd.

The composition of gas ash includes: 5.43% of CaO, 10.37% of SiO₂, 5.75% of Al₂O₃, 34.96% of Fe₂O₃, 1.59% of MgO, 0.13% of SO₃, 0.91% of K₂O, 0.39% of Na₂O, and 40.48% of loss-on-ignition.

### Example 1

This example provided a method for preparing cement clinker, comprising the following steps:
1) preparing cement raw meal by mixing 81.34% of limestone, 7.94% of coal-fired slag, 1.98% of iron tailings, 7.93% of gas ash and 0.81% of fly ash according to the raw material composition of the cement raw meal, wherein the fly ash was obtained by combusting pulverized coal of bituminous coal to 815° C., and the powder of limestone, coal-fired slag, iron tailings, gas ash and fly ash had an 80 μm sieve residue of 5%; and
2) calcining the cement raw meal under an oxygen-rich atmosphere to obtain the cement clinker, wherein the oxygen-rich atmosphere was mixed gas of oxygen and carbon dioxide with a volume ratio of 0.61:0.39, the calcining was performed at a temperature of 1,450° C. for a time period of 75 min.

### Example 2

This example provided a method for preparing cement clinker, which differed from Example 1 only in that the oxygen-rich atmosphere in step 2) was mixed gas of oxygen and carbon dioxide in a volume ratio of 0.51:0.49.

### Example 3

This example provided a method for preparing cement clinker, which differed from Example 1 only in that the oxygen-rich atmosphere in step 2) was mixed gas of oxygen and carbon dioxide in a volume ratio of 0.41:0.59.

### Example 4

This example provided a method for preparing cement clinker, which differed from Example 1 only in that the oxygen-rich atmosphere in step 2) was mixed gas of oxygen and carbon dioxide in a volume ratio of 0.31:0.69.

### Example 5

This example provided a method for preparing cement clinker, which differed from Example 1 only in that the oxygen-rich atmosphere in step 2) was mixed gas of oxygen and carbon dioxide in a volume ratio of 0.21:0.79.

### Example 6

This example provided a method for preparing cement clinker, which differed from Example 1 only in that the oxygen-rich atmosphere in step 2) was mixed gas of oxygen and carbon dioxide in a volume ratio of 0.41:0.59, and the calcining was performed at 1,430° C. for 75 min.

### Example 7

This example provided a method for preparing cement clinker, which differed from Example 1 only in that the oxygen-rich atmosphere in step 2) was mixed gas of oxygen and carbon dioxide in a volume ratio of 0.31:0.69, and the calcining was performed at 1,430° C. for 60 min.

### Example 8

This example provided a method for preparing cement clinker, which differed from Example 1 only in that the oxygen-rich atmosphere in step 2) was mixed gas of oxygen and carbon dioxide in a volume ratio of 0.21:0.79, and the calcining was performed at 1,430° C. for 75 min.

### Example 9

This example provided a method for preparing cement clinker, which differed from Example 1 only in that the oxygen-rich atmosphere in step 2) was mixed gas of oxygen and carbon dioxide in a volume ratio of 0.41:0.59, and the calcining was performed at 1,450° C. for 45 min.

### Example 10

This example provided a method for preparing cement clinker, which differed from Example 1 only in that the oxygen-rich atmosphere in step 2) was mixed gas of oxygen and carbon dioxide in a volume ratio of 0.21:0.79, and the calcining was performed at 1,450° C. for 45 min.

### Example 11

This example provided a method for preparing cement clinker, which differed from Example 1 only in that the oxygen-rich atmosphere in step 2) was mixed gas of oxygen and carbon dioxide in a volume ratio of 0.61:0.39, and the calcining was performed at 1,450° C. for 60 min.

### Example 12

This example provided a method for preparing cement clinker, which differed from Example 1 only in that the oxygen-rich atmosphere in step 2) was mixed gas of oxygen and carbon dioxide in a volume ratio of 0.51:0.49, and the calcining was performed at 1,450° C. for 60 min.

### Example 13

This example provided a method for preparing cement clinker, which differed from Example 1 only in that the oxygen-rich atmosphere in step 2) was mixed gas of oxygen and carbon dioxide in a volume ratio of 0.31:0.69, and the calcining was performed at 1,470° C. for 45 min.

### Example 14

This example provided a method for preparing cement clinker, which differed from Example 1 only in that the oxygen-rich atmosphere in step 2) was mixed gas of oxygen and carbon dioxide in a volume ratio of 0.41:0.59, and the calcining was performed at 1,470° C. for 60 min.

### Comparative Example 1

This comparative example provided a method for preparing cement clinker, which differed from Example 1 only in that in step 2), the cement raw meal was placed in a silicon-molybdenum furnace in which the atmosphere can be adjusted, and the calcining was performed under an air atmosphere at 1,450° C. for 75 min to obtain the cement clinker.

### Test Example 1

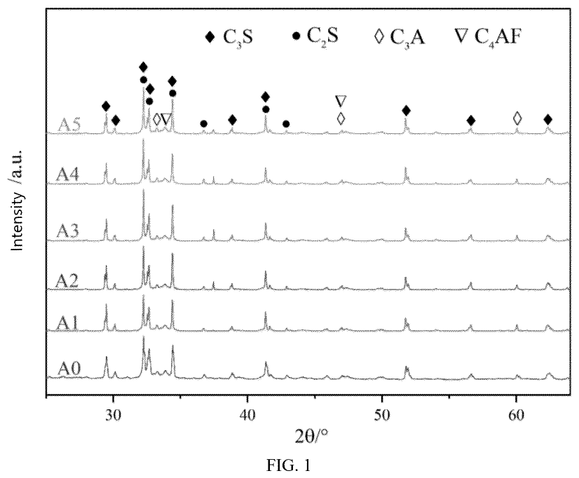

The D8 Advance X-ray diffractometer of Brucker Company of Germany was used to scan the cement clinker of Examples 1-5 and Comparative Example 1, with the following test conditions: accelerating voltage of 40 kV, accelerating current of 40 mA, step size of 0.02°, scanning time of 1 second for each step, and scanning angle of 10-70°. After the end of the scanning, the software MAUD was used to refine the scanned results of the clinker samples using the Rietveld full-spectrum fitting analysis method, and the XRD patterns and refinement results were obtained to determine the mineral phase content. The results of the analyses of the contents of various mineral phases for different samples were shown in Table 1, and the XRD patterns were shown in FIG. 1.

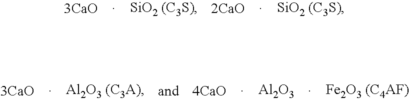

were the four main mineral phases of cement clinker, and the rest was a small amount of miscellaneous mineral phases. Under different calcination regimes, the crystal structure and mineral composition of cement clinker can change significantly. The sample numbers corresponding to Examples 1-5 and Comparative Example 1 were shown in Table 1, which were consistent with the sample numbers in the subsequent test examples.

TABLE 1

| | | Content of main minerals in clinker (wt. %) | | | |
|---|---|---|---|---|---|
| | Sample No. | C₃S | C₂S | C₃A | C₄AF |
| Example 1 | A1 | 61.9 | 13.5 | 2.5 | 21.9 |
| Example 2 | A2 | 64.7 | 12.4 | 2.7 | 20.1 |
| Example 3 | A3 | 69.1 | 11.4 | 2.0 | 17.4 |
| Example 4 | A4 | 63.3 | 14.2 | 2.0 | 20.4 |
| Example 5 | A5 | 66.9 | 11.1 | 2.3 | 19.4 |
| Comparative | A0 | 52.2 | 21.2 | 2.9 | 23.5 |
| Example 1 | | | | | |

As can be seen from Table 1, compared with sample A0 which was calcined in an air atmosphere in Comparative Example 1, the samples in Examples 1-5 which were calcined in an oxygen-rich atmosphere of mixed CO₂/O₂ have more significant increase in the content of C₃S, but have more significant decrease in the content of C₂S, C₃A, and C₄AF. The contents of C₃S and C₄AF changed significantly with the change of CO₂ concentration. It can be seen that the calcination under the oxygen-rich atmosphere of mixed CO₂/O₂ of the present application can significantly increase the content of C₃S in cement clinker.

In addition, when the CO₂ content was relatively low, the content of C₃S in the calcined samples increases gradually with the increase of the CO₂/O₂ ratio. In Example 3, the content of C₃S in sample A3 which was calcined under the atmosphere environment with the CO₂/O₂ ratio reaching 0.59/0.41 reaches the highest (69.1%). Then the content of C₃S begins to show a decreasing trend with the increase of the CO₂/O₂ ratio, and the content of C₃S start to increase again when the CO₂/O₂ ratio reaches 0.79/0.21. Obviously, the effect of CO₂/O₂ atmosphere on the composition of the mineral phase in the calcined samples was relatively complex, which was most likely due to the changes in the temperature of the formation of the mineral phase and the liquid phase caused by the CO₂/O₂ atmosphere during the combustion process. In particular, the content and property of the liquid phase were crucial for the generation of C₃S. The optimal calcining atmosphere was more favorable for the conversion of C₂S to C₃S, resulting in the highest content of C₃S in the clinker. As can be seen from the above results, sample A3 of Example 3 has the highest C₃S content (69.1%), which indicates that when the ratio of CO₂/O₂ is 0.59/0.41, it is the most favorable calcining atmosphere for the growth of C₃S in clinker.

### Test Example 2

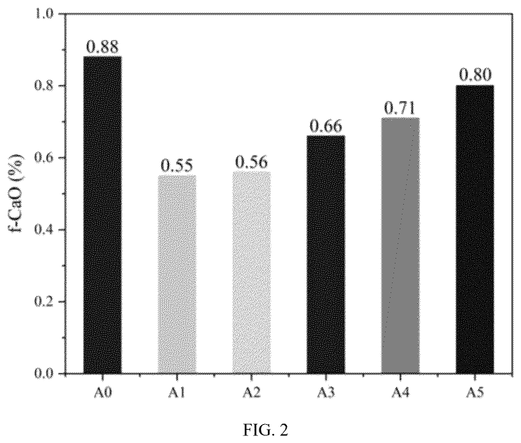

A FC-6 Cement Free Calcium Oxide Rapid Tester was used to determine the free calcium oxide mass content of the cement clinker of Examples 1-5 and Comparative Example 1. The results were shown in FIG. 2.

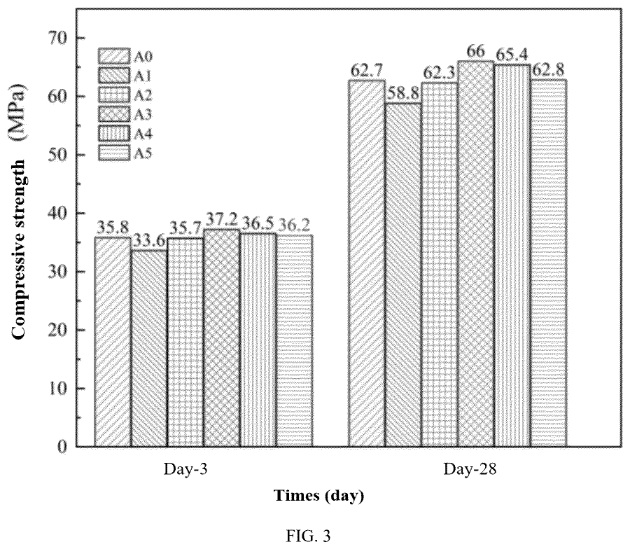

The cement clinker of Examples 1-5 and Comparative Example 1 was crushed until all of the cement clinker passed through a 5 mm square-hole sieve, and then pulverized with natural gypsum dihydrate which meets the provisions of GB/T5483 in a standard test mill to form P·I type portland cement, in which the mass content of natural gypsum dihydrate was 5%. The 3-day and 28-day compressive strength of P·I type portland cement was measured according to GB/T 17671-2021 (Test Method of Cement Mortar Strength (ISO Method)), and the results were shown in FIG. 3.

As can be seen in FIG. 2, the free calcium oxide (f-CaO) content of the samples calcined in air atmosphere was 0.88 wt %, and the f-CaO content of all the samples calcined in CO₂/O₂ atmosphere decreased. This is because the addition of a certain concentration of CO₂ to the atmosphere changed the equilibrium partial pressure of CO₂ in the system and slowed down the decomposition process of carbonate salts. On the other hand, the f-CaO content in the clinker showed an obvious increasing trend as the ratio of CO₂/O₂ increased from 0.39/0.61 to 0.79/0.21. In addition, the f-CaO content of all experimental samples was always lower than 1.0 wt %, which met the f-CaO control requirements for clinker. The increase of free calcium oxide (f-CaO) content in cement clinker will directly affect the stability of cement, so it can be seen that the examples of the present application in which the calcining was performed under CO₂/O₂ atmosphere can ensure the stability of cement and improve the quality of cement.

As can be seen from FIG. 3, the compressive strength of samples A1 to A3 in the examples was increased, and then the compressive strength of samples A4 and A5 was decreased, indicating that a moderate increase in the ratio of CO₂/O₂ concentration was conducive to improving the compressive strength of cement, i.e., it can also reflect that the compressive strength of cement clinker were increased, and the compressive strength of cement clinker was the highest when the ratio of CO₂/O₂ reaches 0.59/0.41 (sample A3); when the ratio of CO₂/O₂ was further increased, the compressive strength started to decrease instead, but even with a ratio of CO₂/O₂ of 0.79/0.21, the compressive strength of the cement clinker was still comparable to that of sample A0 which was calcined under the conventional air atmosphere. That is, the cement clinker obtained by calcining under atmosphere of CO₂/O₂ with concentration ratios of 0.59/0.41, 0.69/0.31, and 0.79/0.21 in Examples 3-5 has high cement clinker compressive strength, and the quality of the cement clinker was further improved.

Moreover, it can be observed that sample A4 showed the highest strength growth rate (79.10%) in the age range of 3-28 days, and sample A3 also showed a relatively high strength growth rate (77.32%). Samples A0, A1 and A2 showed similar strength growth rates, which were all 75.10%, while sample A5 showed a relatively low strength growth rate. These results indicate that CO₂-containing calcining atmosphere has an effect on the strength growth rate of clinker, and the highest strength growth rate of cement clinker was observed when ratios of CO₂/O₂ were 0.59/0.41 and 0.69/0.31.

In summary, it can be seen that the CO₂ calcining atmosphere has an effect on the strength of clinker. When the CO₂/O₂ concentration ratio was in a range from 0.39/0.61 to 0.79/0.21, moderate increase in CO₂/O₂ concentration ratio was conducive to improving the compressive strength of cement clinker. When the ratio of CO₂/O₂ was 0.59/0.41 and 0.69/0.31, the strength of cement clinker was best, and the strength increase rate was greatest over the age range of 3-28 days.

### Test Example 3

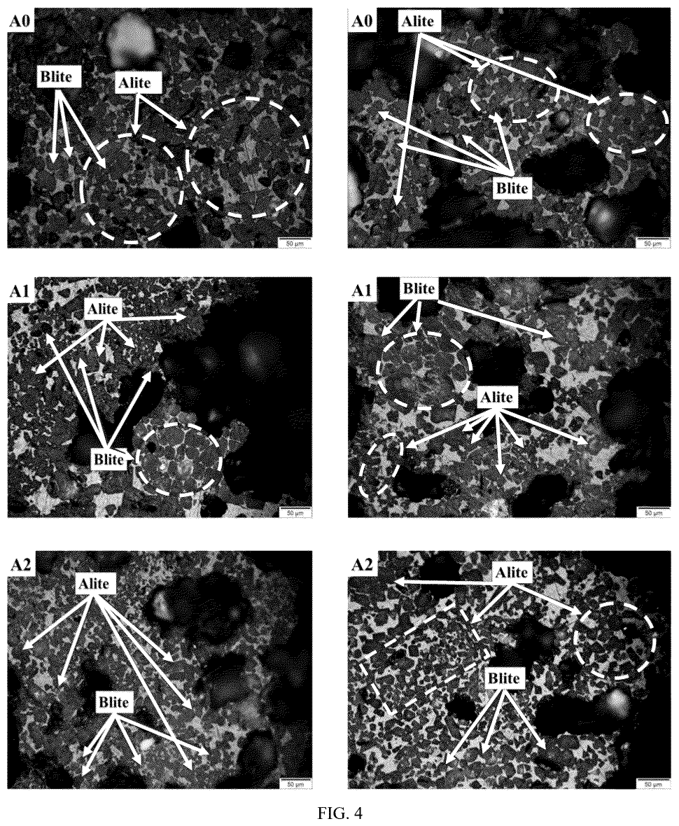

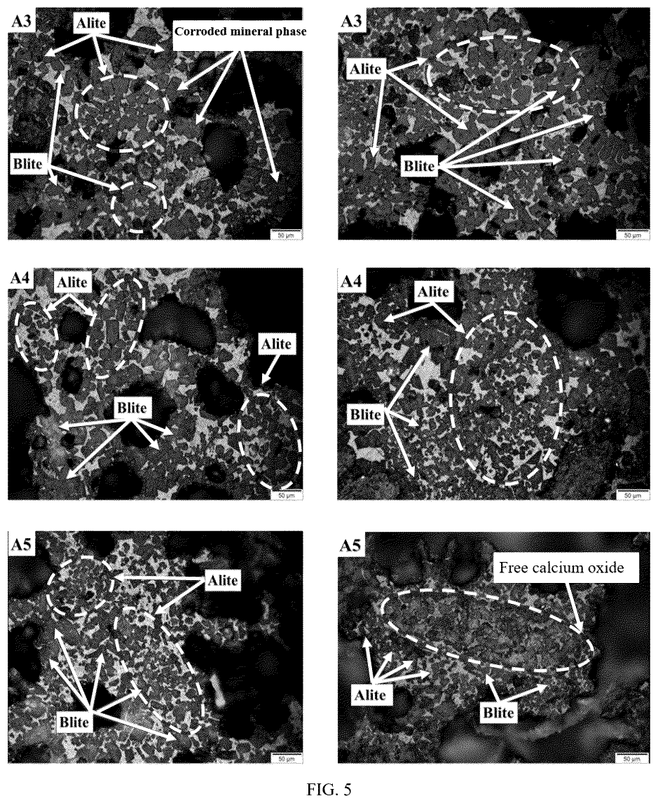

The cement clinker of Examples 1-5 and Comparative Example 1 was fixed with phenolic resin and then ground flat and polished, and the flat surface of the samples were corroded using ammonium chloride solution (wt %=1%), and the microstructural observations, measurements and analyses of the cement clinker of Examples 1-5 and Comparative Example 1 were subsequently carried out by using an Olympus BX-51 polarizing microscope. The polarizing microscope images obtained were shown in FIGS. 4 and 5, with two different positions selected for each sample. Observations were made under a polarizing microscope. At this time, the free calcium oxide will be colored, Alite (with the main ingredient of C₃S) crystals were mainly blue or dark brown, with hexagonal or square shapes, and Belite (with the main ingredient of C₂S) crystals were light brown with round shapes.

The sub-microstructures of clinker minerals obtained from different calcining atmospheres can be seen in FIGS. 4 and 5. Comparison of the mineral morphology of the six groups of samples under the reflected light microscope shows that when the calcining atmosphere was changed from air to CO₂/O₂, the number of Alite crystals in the clinker becomes larger, the size becomes larger, and the boundaries become clearer. With the change of the ratio of CO₂/O₂ in the calcining atmosphere, Alite crystals in clinker become larger in size and have clearer and more complete outlines, while Belite crystals become smaller in size and have blurrier outlines. Among all the samples, sample A3 shows the best crystal morphology. Most of the Alite crystals in sample A3 were relatively regular and complete in shape, mostly were hexagonal plates and short columns, with uniform size, more quantity (about 60%-70%), and more inclusions. Belite crystals were fewer in number, with moderate size, most of them were ellipsoidal and egg-shaped, with smooth edges, and a few of them have grain lines and crossbands. On the other hand, A0 sample of the comparative example has less Alite crystals, irregular shape, uneven size, blurred edges, and more adhesion among the minerals; Belite crystals can be seen in the field of view with higher content, basically rounded shape, smooth edges, and C₃S scattered among them.

### Test Example 4

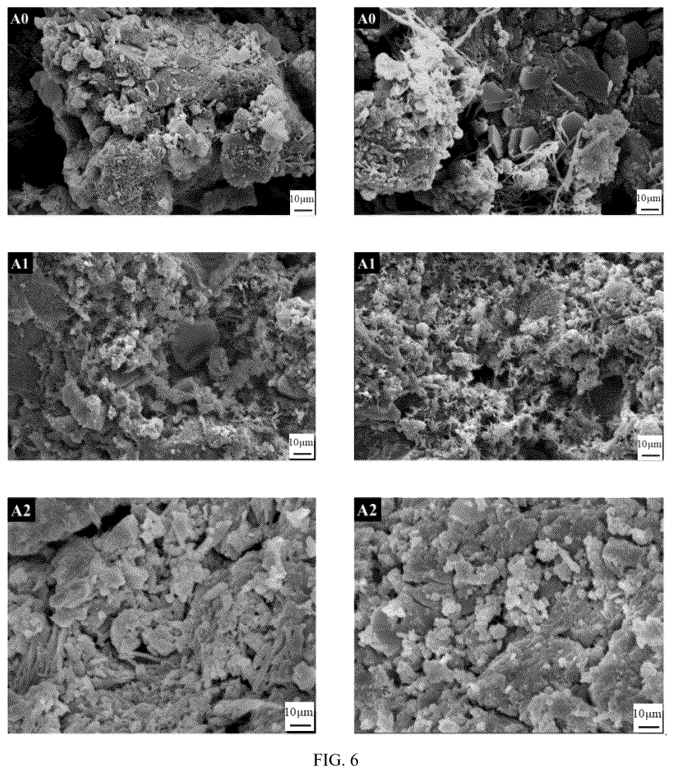

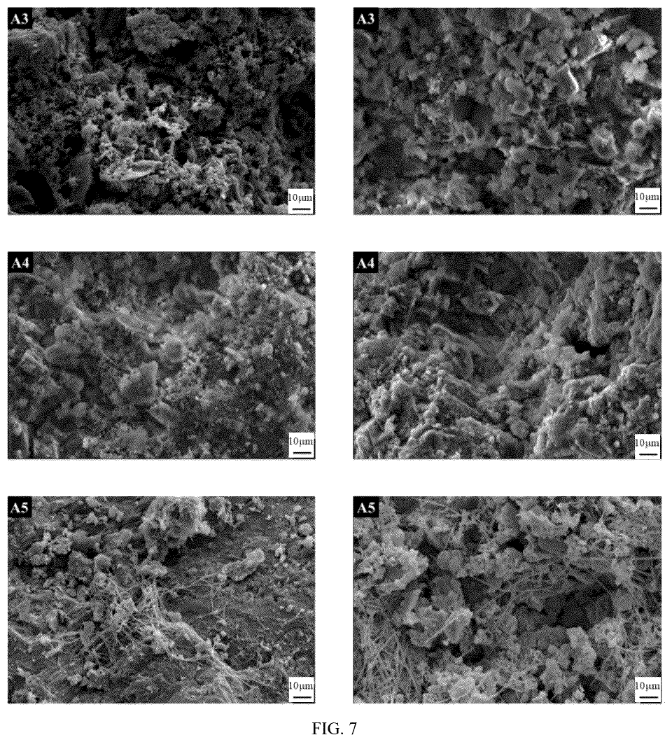

The cement clinker of Examples 1-5 and Comparative Example 1 were hydrated for 3 days respectively, and the specific hydration steps included: in accordance with the water-cement ratio of 0.4:1, the cement clinker samples were made into 20 mm×20 mm×20 mm cement paste test blocks, and then demolded after 1 day of maintenance under the condition of standard constant temperature and constant humidity (temperature of 20±1° C., humidity of 95±1%), and further placed in deionized water at 20±1° C. for immersion for 2 days, then the test blocks were removed and cracked, and anhydrous ethanol was used to terminate hydration for subsequent testing and analysis. The hydrated samples of cement clinker of Examples 1-5 and Comparative Example 1 were characterized using field emission scanning electron microscopy (UltraPlus, Zeiss), to observe the size and morphology of crystals formed after the hydration of cement clinker, and the obtained scanning electron micrographs were shown in FIGS. 6 and 7, with two different positions selected for each sample.

FIGS. 6 and 7 show the surface microscopic morphology of clinker after hydration (for 3 days) obtained from different calcining atmospheres. From the images, it can be seen that the hydrated products on the surface of the samples with different calcining atmospheres were basically the same, i.e., the early product of hydration, type I hydrated calcium silicate (C—S—H), which was an elongated substance that grows radially outward from the cement particles. However, the distribution of hydrated products on the surface of A0 and A1 was more dispersed and the difference in mineral sizes was larger; sample A2 showed slat-like and tubular C—S—H; the mineral distribution of A3 and A4 was homogeneous and denser, and the cogwheel and fibrous C—S—H gels were distributed in staggered agglomerates, which were in the form of interlocking mesh, which suggested that the hydration degree of cement clinker in samples A3 and A4 was high, and that the hydration rate was fast, and also indirectly indicated that the compressive strength of the cements of A3 and A4 performed excellently under the CO₂/O₂ atmosphere ratios in Examples 3 and 4. The distribution of hydrated minerals on the surface of A5 was dispersed, with an increase in the number of inter-mineral grooves and cracks clearly visible, the minerals were small in size and basically completed hydration, and the elongated stripes of particles lap on spherical granular minerals which have already been hydrated, interspersed and distributed within them. On the other hand, sample A0 corresponding to Comparative Example 1 has a low degree of hydration, and there were still more hexagonal plates and short columns.

### Test Example 5

The free calcium oxide content in cement clinker of Examples 6-14 was determined using FC-6 Cement Free Calcium Oxide Rapid Determiner. The test results were shown in Table 4.

The cement clinker of Examples 6-14 was scanned with a D8 Advance X-ray diffractometer from Brucker, Germany, under the following test conditions: accelerating voltage of 40 kV, accelerating current of 40 mA, step size of 0.02°, scanning time of 1 second per step, and scanning angle of 10-70°. At the end of the scanning, the clinker samples scanned results were refined using the software MAUD using the Rietveld full-spectrum fitting analysis method to determine the mineral phase content. The test results were shown in Table 4.

The cement clinker of Examples 6-14 was crushed until all of the cement clinker passed a 5 mm square-hole sieve, and then pulverized with natural gypsum dihydrate which meets the provisions of GB/T5483 in a standard test mill to form P·I type portland cement, in which the mass content of natural gypsum dihydrate was 5%. The 3-day and 28-day compressive strength of P·I type portland cement was measured according to GB/T 17671-2021 (Test Method of Cement Mortar Strength (ISO Method)), and the results were shown in FIG. 4.

Lithofacies scoring was carried out on the cement clinker obtained in Example 4 and Examples 6-14, and the lithofacies scoring was carried out by using Olympus BX-51 polarizing microscope to observe the microstructure of the clinker. The scores were determined on the basis of: the porosity, the size of the holes as well as their dimensions; the mineral content, the degree of erosion and the degree of uniformity of distribution; and the shapes and dimensions of crystals as well as their sizes, etc. The lithofacies scoring criteria were shown in Table 3, and the test results were shown in Table 4.

TABLE 3

| | Appearance | Score (Total 9) |
|---|---|---|
| Pore | Small porosity, dense structure, without | 3 |
| | obvious hole | |
| | Smaller porosity, observed the existence | 2 |
| | of holes, the diameter of the holes | |
| | being basically less than 50 μm | |
| | Relatively large porosity, observed the | 1 |
| | existence of more holes, the diameter of | |
| | the holes being greater than 50 μm but | |
| | less than 100 μm | |
| | Large porosity, observed the existence | 0 |
| | of many holes, the diameter of the holes | |
| | being greater than 100 μm | |
| Mineral | High C₃S content, uniform distribution, | 3 |
| content | only sporadic f-CaO can be observed | |
| | Relatively high C₃S content, relatively | 2 |
| | uniform distribution, scattered f-CaO | |
| | can be observed | |
| | Relatively low C₃S content with | 1 |
| | relatively uniform distribution, high | |
| | C₂S content with relatively uniform | |
| | distribution, scattered f-CaO can be | |
| | observed | |
| | Low C₃S content, high C₂S content, | 0 |
| | non-uniform distribution, a large number | |
| | of agglomerated f-CaO can be observed | |
| Crystal | Alite crystals are large in size, with | 3 |
| | clear and complete outlines; Belite | |
| | crystals are small in size, with blurred | |
| | outlines | |
| | Alite crystals are relatively large in | 2 |
| | size, with clear and relatively complete | |
| | outlines; Belite crystals are relatively | |
| | small in size, with relatively blurred | |
| | outlines | |
| | Alite crystals are relatively small in | 1 |
| | size, with relatively blurred outlines; | |
| | Belite crystals are relatively small in | |
| | size, with clear outlines | |
| | Alite crystals are small in size, with | 0 |
| | blurred outlines; Belite crystals are | |
| | large in size, with clear outlines | |

TABLE 4

| | C₃S content (wt %) | f-CaO (wt %) | Lithofacies scoring |
|---|---|---|---|
| Example 4 | 60.4 | 0.66 | 8 |
| Example 6 | 58.2 | 0.71 | 6 |
| Example 7 | 59.3 | 0.77 | 5 |
| Example 8 | 60.5 | 0.65 | 8 |
| Example 9 | 60.3 | 0.71 | 6 |
| Example 10 | 61.9 | 0.8 | 6 |
| Example 11 | 61.8 | 0.57 | 5 |
| Example 12 | 63.9 | 0.55 | 6 |
| Example 13 | 61.4 | 0.54 | 7 |
| Example 14 | 63.7 | 0.62 | 8 |
| Comparative | 52.2 | 0.88 | 4 |
| Example1 | | | |

Obviously, the above examples are merely examples for the purpose of clear illustration and are not a limitation of the embodiments. To those skilled ordinary in the art, other variations or changes in different forms may be made on the basis of the above description. It is neither necessary nor possible to exhaust all of the embodiments herein. The obvious variations or changes derived therefrom remain within the scope of protection of the present application.

1. A method for preparing cement clinker, comprising the following steps:
1) preparing cement raw meal; and
2) calcining the cement raw meal under an oxygen-rich atmosphere, the oxygen-rich atmosphere being mixed gas of oxygen and carbon dioxide in a volume ratio of (0.21-0.61):(0.39-0.79).

2. The method of claim 1, wherein the volume percentage of oxygen in the oxygen-rich atmosphere in step 2) is in a range from 21% to 50%.

3. The method of claim 2, wherein the volume percentage of oxygen in the oxygen-rich atmosphere in step 2) is 31% or 41%.

4. The method of claim 1, wherein the calcining in step 2) is performed at a temperature ranging from 1,430° C. to 1,470° C. for a time period ranging from 45 min to 75 min.

5. The method of claim 1, wherein the composition of the raw materials of the cement raw meal in step 1) comprises the following by weight: 75-85 parts of limestone, 5-15 parts of coal-fired slag, 1-5 parts of iron tailings and 5-10 parts of gas ash.

6. The method of claim 5, wherein the composition of the raw materials of the cement raw meal in step 1) further comprises fly ash; and
the fly ash is added in an amount of 0.8% to 4% of the total mass of the raw materials of the cement raw meal.

7. Cement clinker prepared by the method for preparing cement clinker as claimed in claim 1.

8. The cement clinker of claim 7, wherein the cement clinker comprises the following mineral phases by mass percentage: 58% to 70% of C₃S, 10% to 17% of C₂S, 2.0% to 2.7% of C₃A, 17% to 23% of C₄AF, and miscellaneous mineral phases as a balance.

9. The cement clinker of claim 8, wherein the cement clinker comprises the following mineral phases by mass percentage: 69.1% of C₃S, 11.4% of C₂S, 2.0% of C₃A, 17.4% of C₄AF, and miscellaneous mineral phases as a balance; or,
the cement clinker comprises the following mineral phases by mass percentage: 63.3% of C₃S, 14.2% of C₂S, 2.0% of C₃A, 20.4% of C₄AF and miscellaneous mineral phases as a balance.

10. A cement material comprising the cement clinker as claimed in claim 7.
